(19) United States
(12) Patent Application Publication
(10) Pub. No.: US 2026/0349760 A1
(43) Pub. Date: Nov. 5, 2026

(54) Method and apparatus for creating a graphical interface to at least one sensor

(71) Applicant: SICK AG, Waldkirch (DE)

(72) Inventors: Richard JAHNER, Umkirch (DE); Valerij WITTENBECK, Karlsruhe (DE); Daniel BRUNO, Lörrach (DE); Marcel FINGER, Düsseldorf (DE)

(21) Appl. No.: 19/648,235

(22) Filed: Apr. 15, 2026

(30) Foreign Application Priority Data
May 2, 2025 (EP) 25174009.8

(51) Int. Cl. G06F 9/451; G06F 40/205

(52) U.S. Cl. CPC G06F 9/451; G06F 40/205

(57) ABSTRACT

A method for creating a graphical interface to at least one sensor comprises: transmitting sensor description data to a language model, in particular to a large language model, wherein the sensor description data describe the at least one sensor; transmitting display data to the language model, wherein the display data have information with respect to data of the at least one sensor to be displayed in the graphical interface; and instructing the language model to create the graphical interface based on the sensor description data and the display data.

The invention relates to methods and apparatus for creating a graphical interface to at least one sensor.

Sensors are used for a variety of applications to measure different physical, chemical or biological variables and to convert them into digital signals. Common areas of use are as follows:

Industry and automation: Monitor sensors and control production processes, measure temperature, pressure, humidity and vibrations to operate machines efficiently and to recognize errors at an early stage;

Medicine: In medical technology, sensors measure vital signs such as heart rate, blood oxygen level, blood pressure and temperature to monitor patients in real time;

Automotive industry: Sensors in vehicles help prevent accidents by measuring variables such as distance, speed and environmental temperature, and sensors can also be integrated into assistance systems such as parking aids or driver assistance systems;

Environmental monitoring: Sensors measure environmental factors such as air quality, water level, temperature and pollutant concentrations in order to protect the environment and to be able to respond to changes;

Household and smart homes: In modern household appliances, such as air conditioners or refrigerators, sensors measure different environmental conditions to optimize the energy efficiency, wherein smart lighting systems and security systems can also use sensors for movement recognition or monitoring;

Technology and consumer electronics: Smartphones, wearables and other devices use sensors to track movements, to measure environmental light or to recognize the orientation —for example, when using GPS or when controlling functions such as screen brightness.

Sensors are thus of central importance in virtually every technological field to monitor and control systems and to respond to external influences.

However, the configuration of sensors or the acquisition and display of measurement values that are determined by the sensors can be tedious.

Currently, the programming of interfaces for sensors (e.g. IO-Link master gateways) is performed manually. This requires the understanding of the device description and device interfaces (e.g. IO (Input/Output) Device Descriptions (IODDs)), the writing of code to connect to different communication interfaces (e.g. IoT (Internet of Things), fieldbus, IO-Link, Ethernet), and the testing of the implementation to ensure that the interface functions as expected. A commonly used method comprises performing a manual implementation by means of software development kits (SDKs) and OpenAPI specifications that allows a specific adaptation to the respective use cases. However, these methods are time-consuming, require specific knowledge of the communication protocols used and often lead to errors in the implementation.

Methods used to date for creating an interface to a sensor require a high complexity and a great deal of effort during the manual implementation of interfaces. Furthermore, the susceptibility to errors due to manual programming is high. In addition, well-founded knowledge of communication protocols and technologies is required, which limits access for less experienced users. Due to the necessity for specialized developers and dedicated hardware, long development times and high costs are to be expected. So far, generic approaches have only worked with known sensors in the same product category (e.g. distance sensors).

It is the object of the invention to provide a simple and efficient programming of interfaces for sensors.

The object is satisfied by a method having the features of claim 1, an apparatus having the features of claim 14, and a computer readable storage medium having the features of claim 15.

A method according to the invention for creating a graphical interface to at least one sensor comprises: transmitting sensor description data to a language model, wherein the sensor description data describe the at least one sensor; transmitting display data to the language model, wherein the display data have information with respect to data of the at least one sensor to be displayed in the graphical interface; and instructing the language model to create the graphical interface based on the sensor description data and the display data.

The method in particular provides interfaces for transmitting sensor description data to a language model, wherein the sensor description data describe the at least one sensor; for transmitting display data to the language model, wherein the display data have information with respect to data of the at least one sensor to be displayed in the graphical interface; and for instructing the language model to create the graphical interface based on the sensor description data and the display data.

In other words, a language model is used to program an interface in the context of sensors in order to create an interface to one sensor or to a plurality of sensors.

The language model is in this respect a trained machine learning algorithm, for example a Large Language Model (LLM) or a Small Language Model (SLM). The language model can include a plurality of LLMs connected behind one another and/or a plurality SLMs connected behind one another. The object of the language model is in this respect code generation and specialized language models can be used for this purpose.

A large language model (LLM) is an artificial neural network that has been trained to understand and generate language. It uses large amounts of text data to recognize patterns and correlations in the language and to generate answers based thereon. These models work with a high number of parameters that enable the ability to process language at a high level.

A small language model is a small language model trained with specific data to generate individually adapted outputs.

In one embodiment, the sensor description data are transmitted in a prompt to the large language model. This transmission can take place with every instruction for creating the graphical interface. It is therefore not necessary to train the language model specifically with the sensor description data. A standard language model can therefore be used.

In one embodiment, input data are transmitted as prompt components to the language model. The input data can have a system prompt, a user prompt, and context data.

The system prompt can include information about the following: available sensors, and/or supported interfaces and data types, and/or basic system parameters.

The user prompt can include information about the following: a natural language description of the desired interface.

The context data can include information about the following: IODD information of the devices involved.

The sensor description data can be based on a device description. For example, the device description can be an IO (input/output) device description (IODD).

In one embodiment, the device description can be divided into a plurality of snippets. A snippet can in this respect be understood as a (short) excerpt or a summary from a larger text. This makes it possible to divide the device description, which can be very large, into smaller parts. A further reduction in the size of the data to be transmitted to the LLM can be achieved by calculating embeddings of the plurality of snippets and by using the embeddings as sensor description data.

Embeddings can be mathematical representations of words, sentences or other data points in a continuous vector space. Due to embeddings, the text data of the device description or of the snippets can be brought into a form that has a reduced data volume and that is easier for the LLM to process. The embeddings can be generated by training processes in which a model processes large amounts of text data. During this training, the model learns to recognize semantic relationships between words and to encode them in vectors. For example, the embeddings can be generated using the following methods: Word2Vec, GloVe (Global Vectors for Word Representation), or BERT and GPT.

The method can further comprise: transmitting communication interface descriptions to the language model. The communication interface descriptions can, for example, include or be OpenAPI specifications.

The method can further include requesting the display data from a user. In this respect, the user can enter the display data in natural language and does not have to refer to details of the technical characteristics of the sensor. The use of the method is thereby also not possible for personnel with no training or less training.

In one embodiment, the method further comprises transmitting an example of a description of a graphical interface to the language model. The LLM is therefore provided with an example of what a graphical interface can look like and how it can be programmed so that the LLM can create the graphical interface accordingly.

The method can further comprise obtaining data that describe the graphical interface from the language model. This can be carried out by the LLM in response to the instruction.

In one embodiment, the method can further comprise instructing the language model to adapt the graphical interface. Thus, an iteration of the creation of the graphical interface by the user can take place. The user can in this respect submit change requests for the graphical interface to the LLM. The method in this respect provides an interface for instructing the language model to adapt the graphical interface.

The data that describe the graphical user interface can be specified in an HTML format. The actual result—i.e. the part of the response of the LLM that describes the graphical interface—can be referred to as an artifact.

In a further development, the method can further comprise instructing the large language model to create chain-of-thought prompting information. Chain-of-thought prompting is in this respect a technique to cause the language model to show a comprehensible way of thinking. Instead of only providing a direct answer, the LLM is encouraged to present its “thoughts” in a logical sequence, which can lead to more accurate and well-founded results.

In one embodiment, the language model can be a large language model. The large language model can have, be, or be based on at least one of the following models: ChatGPT or Deepseek.

The object of the invention is further satisfied by an apparatus for creating a graphical interface to at least one sensor, said apparatus comprising the following: means for transmitting sensor description data to a language model, wherein the sensor description data describe the at least one sensor; means for transmitting display data to the language model, wherein the display data have information with respect to data of the at least one sensor to be displayed in the graphical interface; and means for instructing the language model to create the graphical interface based on the sensor description data and the display data.

The object of the invention is further satisfied by a computer readable storage medium comprising commands that, on execution by a computer, cause it to carry out the method described herein.

Further advantageous embodiments of the method according to the invention result from the dependent claims, the drawing, and the description.

The invention will be described in the following with reference to embodiment examples and to the drawing. There are shown in schematic representations:

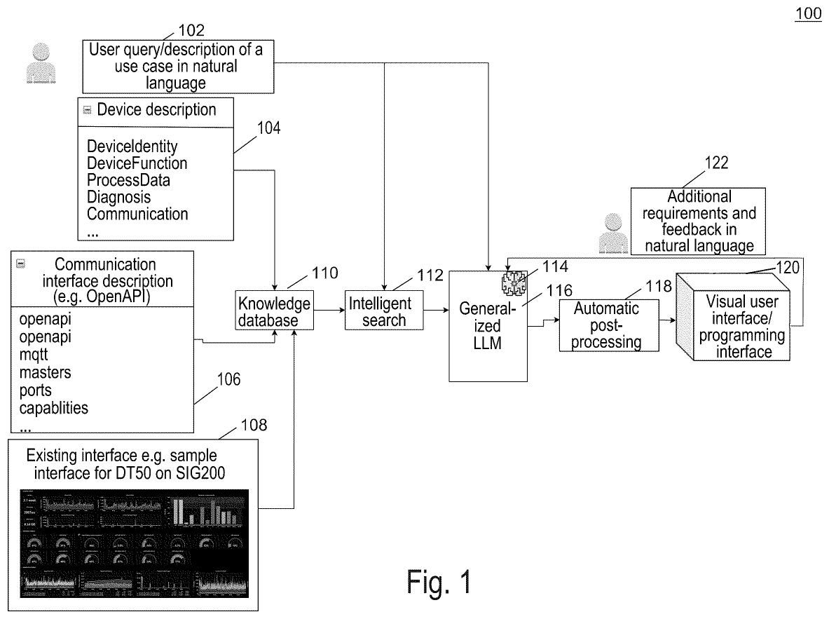

FIG. 1 a system diagram of a system for creating a graphical interface to at least one sensor according to an embodiment;

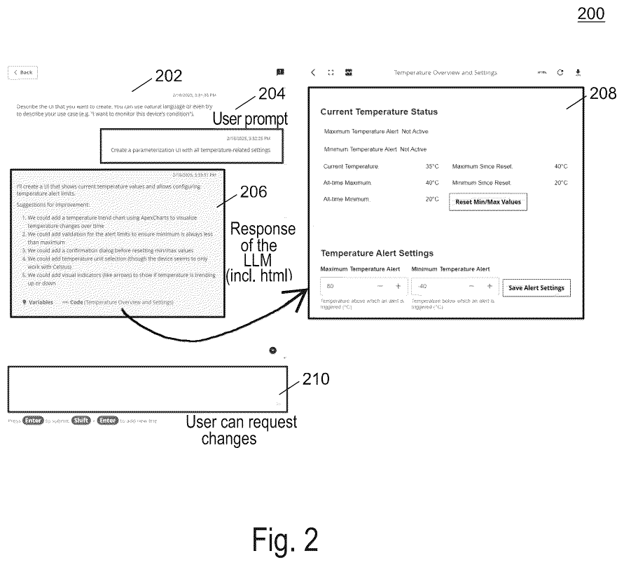

FIG. 2 an illustration of a generation of a graphical user interface for an IO-Link device according to an embodiment;

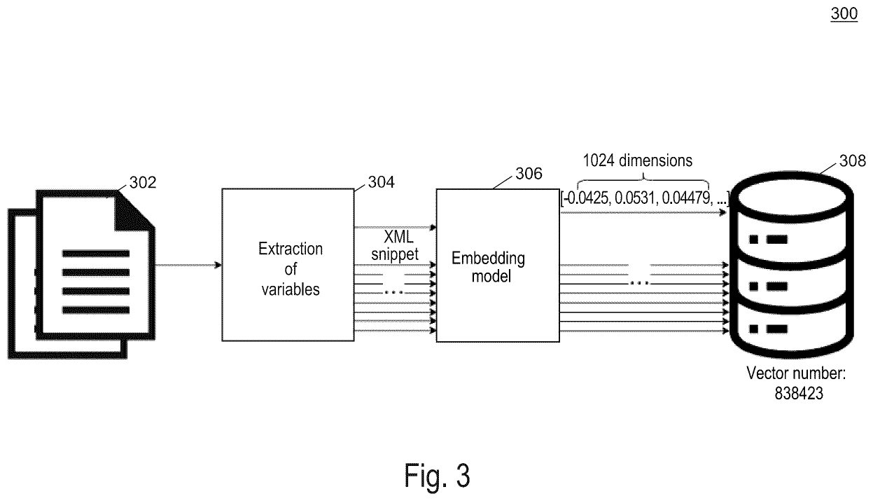

FIG. 3 an illustration of a generation of embeddings for the device description according to an embodiment; and

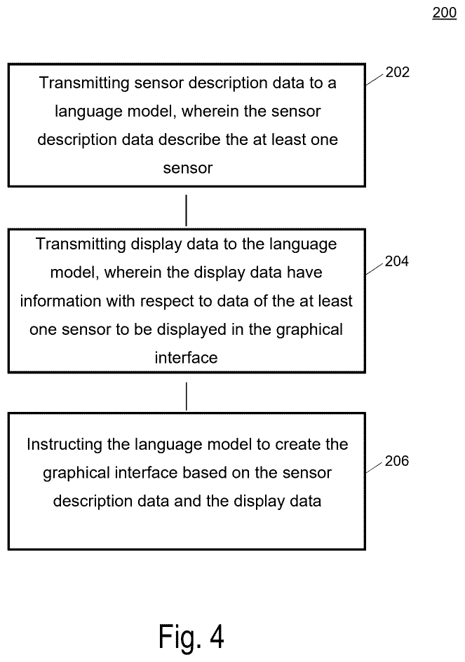

FIG. 4 a flowchart that illustrates a method for creating a graphical interface to at least one sensor according to an embodiment.

In the following, the methods and apparatus according to the invention will be explained in an exemplary manner with reference to embodiment examples.

According to the invention, a simple and efficient programming of interfaces for sensors is provided.

The methods and apparatus according to different embodiments can be applied in the field of industrial automation, in particular in environments in which sensors and actuators communicate with a plurality of standardized control systems. One sensor group in which this works very well due to the requirements is IO-Link master gateways. The LLM enables a simplified programming and configuration of interfaces in production environments in which flexibility, efficiency and user-friendliness are particularly important. The use of natural language for interface creation ensures that even users without extensive programming knowledge are able to make the necessary adaptations.

The methods and apparatus according to the embodiments can program an interface that can be used in an industrial environment to efficiently design the communication and control of sensors (for example IO-Link master gateways).

Traditionally, the programming of an interface requires in-depth specialist knowledge of communication protocols, device-specific protocols (e.g. IO-Link specifications), and the underlying technologies such as IoT, fieldbus or Ethernet. These manual processes are complex and prone to errors and require a great deal of effort. According to the invention, due to the use of an LLM, the development of an interface (for example a visual user interface or program interface) for the sensors (e.g. IO-Link master gateways) can now be automated and simplified so that users without in-depth technical knowledge are capable of programming such an interface.

FIG. 1 shows a system diagram 100 of a system for creating a graphical interface to at least one sensor according to an embodiment. In step 102, the user query, for example the description of a use case in natural language, takes place. A device description 104, a communication interface description 106 and an example 108 of an existing interface form a knowledge database 110. The knowledge database 110 is used together with the user query 102 for an intelligent search 112 whose output is passed on together with the user query to a (generalized) LLM 116. The output of the LLM 116 is fed to an automatic post-processing 118 whose output is a visual user interface/programming interface 120. Additional requirements and feedback of the user can be fed in 122 in natural language to the LLM 116, wherein the LLM can store the previous considerations regarding the generation of the interface (as visualized in 114) so that an update of the generated visual user interface/programming interface can then take place based on the most recently generated interface 120 and the additional requirements 122.

According to different embodiments, an automated programming of a visual user interface/programming interface for sensors (e.g. IO-Link master gateways) is provided by means of a generic large language model (LLM). At runtime, this LLM uses a knowledge database that represents the domain knowledge (for example, a device description, a communication interface description, existing visual user interface descriptions/programming interface descriptions). The required information of the knowledge database is determined on the basis of an intelligent search (e.g. retrieval-augmented generation). Based on the user query or the description of the use case, the LLM automatically generates code that meets the necessary requirements and considers the existing information of the knowledge database in so doing.

The output of an LLM is automatically post-processed. During the post-processing, the initial artifacts are generated or change requests are applied, for example. Furthermore, the user can check the visual user interface/programming interface and can verbalize feedback and additional requirements in order to iteratively adapt or improve the generated result. The final result is in turn incorporated into the knowledge database.

In this respect, the interaction with the LLM can always take place in natural language via simple text requests (prompts). When generating the visual user interface/programming interface, all the specifications and all the relevant connection parameters and communication protocols can be considered.

The knowledge database can, for example, include the following information:
device description (e.g. IO (input/output) Device Descriptions (IODDs), manuals): descriptions that include the functionalities and parameters of the connected sensors and actuators; and/or
communication interface descriptions (e.g. OpenAPI specifications): these specifications provide the basic information for creating the interfaces that are required in the communication; and/or
sample implementations: existing implementations and code examples are used to provide the LLM with real use cases, to establish a solid foundation for the generation and to convey implicit requirements.

FIG. 2 shows an illustration of a generation of a graphical user interface for an IO-Link device according to one embodiment. In 202, the user is requested to enter his input. 204 shows the part of the user prompt that is entered by the user; according to the invention, this part is then supplemented with the information from the knowledge database and/or detailed instructions for the LLM for generating the interface. The response of the LLM 206 includes HTML code that describes the user interface 208.

For the use of the LLM, it is a requirement that the IO-Link Device Description (IODD) of the device is known. It will become part of the system prompt.

The input data to the LLM (which are transferred as prompt components to the LLM) can include the system prompt, the user prompt, and the context data.

The system prompt (which can be a constant base context) can include information about the following: available sensors, and/or supported interfaces and data types, and/or basic system parameters.

The user prompt (which can be variable) can include information about the following: a natural language description of the desired interface.

The context data (which can be dynamic) can include information about the following: IODD information of the devices involved.

A exemplary system prompt is shown in Annex 1.

In the system prompt, the context in which the LLM is used (for example, “Your job is to assist the user with creating a functional graphical user interface. . . ”) can be set. Furthermore, the available sensors (for example, “Here is the IOLink device description for a device the user is working with: . . . ”), the supported interfaces and data types (for example, “Data format: . . . ”) and/or basic system parameters are specified. Furthermore, the task for the language model can be defined (for example, “It is very important to follow this order in your answer. . . ” and/or “It is very important that you always follow these rules: . . . ”).

A prompt, in particular a system prompt, in a language model such as a large language model or a small language model refers to a specific type of input that provides the model with certain instructions or contexts regarding how it should behave during a conversation or task. This prompt is usually used to guide or focus the behavior of the model in a specific way.

An example of an iodd is shown in Annex 2.

The raw data of a sample chat with the LLM can, for example, be as shown in Annex 3.

In one embodiment, the LLM can be requested to divide each response into sections that can then be parsed from the response. For example, the LLM can be requested to evaluate the response of the LLM by a chain-of-thought prompting under the point “<thinking>” that can normally be hidden from the user. Furthermore, the LLM can be requested to provide a single HTML page, which represents the interface, under the point “<artifact>”. This interface can be graphically displayed in an application.

A further exemplary chat is shown in Annexes 4 and 5, wherein the user prompt is shown in Annex 4 and the response of the LLM is shown in Annex 5.

The user prompt can include a natural language description of the desired interface that, in the example shown in Annex 4, is implemented as a list with requirements (such as “I want. . . ”, “Make . . . ”, “Provide . . . ”).

The use of the entire IODD/device description cannot be scalable, for example, due to the limited context size of the LLM. Furthermore, the device description often does not include all the information (for example, units can be missing: it can, for example, not be specified whether the unit of the temperature is Celsius or Fahrenheit or whether the distance values of a sensor are specified in meters or millimeters). According to one embodiment, other or additional information sources (such as manuals or other UIs (user interfaces)) can be used in the knowledge database.

According to different embodiments, fine-tuning may not be necessary. Fine-tuning would require a lot of resources. Without fine-tuning, the LLM can be easily interchangeable. Furthermore, it has been shown that the quality of the results by fine-tuning is not significantly better than by a suitable selection of the prompts (which can be referred to as prompt engineering) and a suitable knowledge database, as both are described herein.

FIG. 3 shows an illustration 300 of a generation of embeddings for the device description according to one embodiment. The device description 302 (for example the IODD) can be divided into snippets 304 (wherein a snippet describes a parameter). From these snippets 304, embeddings 306 can be calculated and written to a vector database 308.

For each query of the user, the embedding of the prompt can then be calculated and the closest matches can be retrieved from the vector database 308 and then become part of the LLM context. This may be similar to a classic RAG (“Retrieval-Augmented Generation”).

However, one problem with RAG may be that imprecise queries do not lead to a good result. Queries such as “Generate a UI with the most important parameters” or “I want to demonstrate the capabilities of the device” do not lead to a good result because a single device parameter has no semantic connection to these statements.

To ensure a consistent UI (with consistent UI elements), the SICK Synergy Design System and the associated web components can be used. Since it is publicly available on GitHub, it can be part of the training data of the final LLM and therefore does not have to be specifically described (for example, in the user prompt).

It can, however, be a problem that the state of knowledge is outdated; in other words, in the long run, the information also does not have to be stored in some kind of knowledge database. Since it also applies here that the number of UI elements with a description could exceed the context, RAG could also be used here.

However, it is a special feature that the user query cannot serve as the basis for the retrieval (of the RAG). The user is responsible for the “what,” and the system for the “how.” In one embodiment, it is therefore possible to have the LLM describe the UI and generate retrieval queries on its own, e.g., “To make the device name editable, I would use a text input field.” For example, the automatically generated request could read: “text input field”. The RAG result could be: Synergy Element “syn-input” (+description, examples, . . . ). Then, a new call of the LLM could be started with a previous separate UI description and the RAG result in order to generate the UI.

With the methods and apparatus of the different embodiments, an automated creation of visual user interfaces/programming interfaces using natural language inputs can be provided, whereby the necessity for in-depth technical knowledge is dispensed with. This furthermore enables the reduction of errors through automatic code generation based on validated data and specifications. Furthermore, an accelerated development can be achieved through a rapid implementation and adaptation of interfaces without a manual programming effort. The different embodiments offer an increased flexibility for the connection of new interfaces and protocols due to the adaptability of the LLM. On the one hand, a cost reduction can be achieved by eliminating the implementation and unnecessary training of an LLM. The different embodiments are independent of specific LLMs since no training has to take place.

The invention can be implemented directly in a device (for example, a device in which the sensors are present) (for example, when a particularly compact LLM is used with low system requirements). Alternatively, an implementation that accesses models in the cloud can take place in a tooling tool (e.g. Sentio Creator).

The different embodiments can be used for all kinds of sensors, for example, SIMs (Sensor Integration Machines), SIGs (Sensor Integration Gateways) and controls that enable a communication with sensors. The embodiments can be used with different tooling tools (for example, Sentio Creator, AppStudio, ConnectX).

FIG. 4 shows a flowchart 400 that illustrates a method for creating a graphical interface to at least one sensor according to an embodiment. In 402, sensor description data are transmitted to a language model. The sensor description data describe the at least one sensor. In 404, display data are transmitted to the language model. The display data include or are information with respect to data of the at least one sensor to be displayed in the graphical interface. In 406, the language model is instructed to create the graphical interface based on the sensor description data and the display data.

In one embodiment, the sensor description data can be transmitted in a prompt to the language model.

In one embodiment, input data are transmitted as prompt components to the LLM. The input data can comprise a system prompt, a user prompt, and context data.

The system prompt can include information about the following: available sensors and/or supported interfaces and data types, and/or basic system parameters.

The user prompt can include information about the following: a natural language description of the desired interface.

The context data can include information about the following: IODD information of the devices involved.

In one embodiment, the sensor description data are based on a device description.

In one embodiment, the device description can be divided into a plurality of snippets.

In one embodiment, embeddings of the plurality of snippets can be calculated and the embeddings can be used as sensor description data.

In one embodiment, communication interface descriptions can be transmitted to the language model.

In one embodiment, the display data can be requested from a user.

In one embodiment, an example of a description of a graphical interface can be transmitted to the language model.

In one embodiment, the data that describe the graphical interface can be obtained from the language model.

In one embodiment, the language model can be instructed to adapt the graphical user interface.

In one embodiment, the data that describe the graphical interface can be specified in a HTML format.

In one embodiment, the language model can be instructed to create chain-of-thought prompting information.

In one embodiment, the language model can include, or be, or be based on at least one of the following models: ChatGPT or Deepseek.

### REFERENCE NUMERAL LIST

100 system diagram of a system for creating a graphical interface to at least one sensor according to an embodiment
102 user query
104 device description
106 communication interface description
108 example of an existing interface
110 knowledge database
112 intelligent search
114 storage in the LLM
116 LLM
118 automatic post-processing
120 visual user interface/programming interface
122 additional requirements and feedback of the user
200 illustration of a generation of a graphical user interface for an IO-Link device according to an embodiment
202 request to the user to enter his input
204 part of the user prompt that is entered by the user
206 response of the LLM 206
208 user interface
300 illustration of a generation of embeddings for the device description according to an embodiment
302 device description
304 snippets
306 embeddings
308 vector database
400 flowchart that illustrates a method for creating a graphical interface to at least one sensor according to an embodiment
402 step for transmitting sensor description data to a language model
404 step for transmitting display data to the language model
406 step for instructing the language model to create the graphical interface based on the sensor description data and the display data

Previos suggestions still apply, and we could also:
1. Add a color temperature indicator (blue-to-red gradient) based on the current temperature
2. Add tooltips showing historical min/max values when hovering over current values
3. Add a visual temperature gauge/thermometer
4. Add keyboard shortcut for theme toggle (e.g., Ctrl+D)

### Annex 4: Example of a user prompt

I want a UI for the following:
1. visualize scan data (auto-update every 500 ms)
1.1. Add a button to toggle whether auto-update is happening
2. A toggle for “Activate Particle Filter”
3. I want to view/edit both fields
4. Make the field color orange when a field is infringed, green otherwise
5. Make parameters like blanking size etc editable
6. Option to save changes permanently
7. Provide feedback to the user when changes were made successfully
8. Make the code easy to follow/debug in case any changes need to be made

1. A method for creating a graphical interface to at least one sensor, the method comprising:
transmitting sensor description data to a language model, wherein the sensor description data describe the at least one sensor;
transmitting display data to the language model, wherein the display data have information with respect to data of the at least one sensor to be displayed in the graphical interface; and
instructing the language model to create the graphical interface based on the sensor description data and the display data.

2. The method according to claim 1,
wherein the sensor description data are transmitted in a prompt to the language model.

3. The method according to claim 1,
wherein the sensor description data are based on a device description.

4. The apparatus according to claim 3, further comprising:
splitting the device description into a plurality of snippets.

5. The method according to claim 4, further comprising:
calculating embeddings of the plurality of snippets; and
using the embeddings as sensor description data.

6. The method according to claim 1, further comprising:
transmitting communication interface descriptions to the language model.

7. The method according to claim 1, further comprising:
requesting display data from a user.

8. The method according to claim 1, further comprising:
transmitting an example of a description of a graphical interface to the language model.

9. The method according to claim 1, further comprising:
obtaining data that describe the graphical interface from the language model.

10. The method according to claim 9, further comprising
instructing the language model to adapt the graphical interface.

11. The method according to claim 1,
wherein the data that describe the graphical interface are specified in an HTML format.

12. The method according to claim 1, further comprising:
instructing the large language model to create chain-of-thought prompting information.

13. The method according to claim 1,
wherein the large language model has, or is, or is based on at least one of the following models: ChatGPT or Deepseek.

14. An apparatus for creating a graphical interface to at least one sensor, the apparatus comprising:
means for transmitting sensor description data to a language model, wherein the sensor description data describe the at least one sensor;
means for transmitting display data to the language model, wherein the display data have information with respect to data of the at least one sensor to be displayed in the graphical interface; and
means for instructing the language model to create the graphical interface based on the sensor description data and the display data.

15. A computer readable storage medium comprising commands that, on execution by a computer, cause it to carry out the method according to claim 1.

16. The method according to claim 1, wherein the language model is a large language model.

17. The apparatus according to claim 14, wherein the language model is a large
language model.
